(19) United States
(12) Patent Application Publication
(10) Pub. No.: US 2019/0200171 A1
(43) Pub. Date: Jun. 27, 2019

(54) ENHANCED DISTRIBUTION OF GROUP-ADDRESSED TRANSMISSIONS IN WIRELESS COMMUNICATIONS

(71) Applicants: Po-Kai Huang, San Jose, CA (US); Laurent Cariou, Portland, OR (US); Yaron Alpert, Hod Hasharon (IL); Arik Klein, Givaat Shmuel (IL); Danny Ben-Ari, Tsur Natan (IL); Amir Hiltron, Beit Ytzhak (IL); Ido Ouzieli, Tel Aviv (IL); Johannes Berg, Detmold (DE); Ofer Hareuveni, Haifa (IL); Gadi Shor, Tel Aviv (IL); Ehud Reshef, Qiryat Tivon (IL)

(72) Inventors: Po-Kai Huang, San Jose, CA (US); Laurent Cariou, Portland, OR (US); Yaron Alpert, Hod Hasharon (IL); Arik Klein, Givaat Shmuel (IL); Danny Ben-Ari, Tsur Natan (IL); Amir Hiltron, Beit Ytzhak (IL); Ido Ouzieli, Tel Aviv (IL); Johannes Berg, Detmold (DE); Ofer Hareuveni, Haifa (IL); Gadi Shor, Tel Aviv (IL); Ehud Reshef, Qiryat Tivon (IL)

(21) Appl. No.: 16/289,360

(22) Filed: Feb. 28, 2019

Related U.S. Application Data
(60) Provisional application No. 62/636,286, filed on Feb. 28, 2018.

(51) Int. Cl. H04W 4/06; H04W 72/00

(52) U.S. Cl. CPC H04W 4/06; H04W 84/12; H04W 72/005

(57) ABSTRACT

This disclosure describes systems, methods, and devices related to group-addressed transmissions in wireless communications. A device may determine a first time associated with a first multicast transmission including a first basic service set (BSS) identifier (BSSID) associated with a first BSS of a multi-BSSID set including the first BSS and a second BSS. The device may send a frame including the first time, the first BSSID, wherein the frame indicates that the second BSS may ignore multicast transmissions at the first time, and wherein the first time is during a beacon interval associated with a beacon addressed to the multi-BSSID set. The device may send the first multicast transmission at the first time and may send a second multicast transmission at a second time, wherein the second time is during the beacon interval, and wherein the second multicast transmission includes a second BSSID associated with the second BSS.

### CROSS-REFERENCE TO RELATED APPLICATION(S)

This application claims the benefit of U.S. Provisional Application No. 62/636,286, filed Feb. 28, 2018, the disclosure of which is incorporated herein by reference as if set forth in full.

### TECHNICAL FIELD

This disclosure generally relates to systems and methods for wireless communications and, more particularly, to group-addressed transmissions.

### BACKGROUND

Wireless devices are becoming widely prevalent and are increasingly communicating with multiple devices. The Institute of Electrical and Electronics Engineers (IEEE) is developing one or more standards that utilize transmissions between wireless devices.

### BRIEF DESCRIPTION OF THE DRAWINGS

FIG. 1 is a network diagram illustrating an example network environment, in accordance with one or more example embodiments of the present disclosure.

FIG. 2A depicts an illustrative portion of a multiple basic service set (BSS) identifier (BSSID) element format, in accordance with one or more example embodiments of the present disclosure.

FIG. 2B depicts an illustrative portion of a multiple BSSID-Index element format, in accordance with one or more example embodiments of the present disclosure.

FIG. 3A depicts an illustrative schematic diagram of a multiple BSSID set, in accordance with one or more example embodiments of the present disclosure.

FIG. 3B depicts an illustrative schematic diagram of a multiple BSSID set, in accordance with one or more example embodiments of the present disclosure.

FIG. 4 depicts an illustrative schematic diagram of a multiple BSSID set, in accordance with one or more example embodiments of the present disclosure.

FIG. 5 depicts an illustrative schematic diagram of a multiple BSSID set, in accordance with one or more example embodiments of the present disclosure

FIG. 6 illustrates a flow diagram of illustrative process for enhanced distribution of group-addressed transmissions for a multiple BSSID set, in accordance with one or more example embodiments of the present disclosure.

FIG. 7 illustrates a functional diagram of an exemplary communication station that may be suitable for use as a user device, in accordance with one or more example embodiments of the present disclosure.

FIG. 8 illustrates a block diagram of an example machine upon which any of one or more techniques (e.g., methods) may be performed, in accordance with one or more example embodiments of the present disclosure.

FIG. 9 is a block diagram of a radio architecture in accordance with some examples.

FIG. 10 illustrates an example front-end module circuitry for use in the radio architecture of FIG. 9, in accordance with one or more example embodiments of the present disclosure.

FIG. 11 illustrates an example radio IC circuitry for use in the radio architecture of FIG. 9, in accordance with one or more example embodiments of the present disclosure.

FIG. 12 illustrates an example baseband processing circuitry for use in the radio architecture of FIG. 9, in accordance with one or more example embodiments of the present disclosure.

### DETAILED DESCRIPTION

Example embodiments described herein provide certain systems, methods, and devices for group-addressed transmissions to multiple basic service sets (BSSs). The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

In wireless communication such as Wi-Fi, stations devices (STAs) may connect to wireless access points (APs). APs may provide wireless networks to which multiple STAs may connect and may form a BSS, which may be identified with a BSS identifier (BSSID). An AP may provide multiple wireless networks to multiple BSSs. For example, an AP may provide a family network and a guest network, or an employee network and a guest network. Multiple BSSs facilitated by an AP may be referred to as a multiple BSSID set (e.g., a set of BSSs with their own respective BSSID). A multiple BSSID set may include a common operating class, channel and channel access functions for any member STAs of the set.

To provide multiple networks/BSSs, a physical AP may use virtual APs, which may refer to logical APs associated with the physical AP. The virtual APs may appear to other devices as individual, distinct APs, but may be provided by a single physical AP. A virtual AP may manage a network for a BSS, and multiple virtual APs may allow a physical AP to transmit to multiple BSSs during a beacon interval for one BSS. Virtual APs may allow a physical AP to manage multiple BSSs using a common channel (e.g., a family network and a guest network on the same frequency channel).

APs may send management frames such as beacon frames and probe response frames to STAs. Beacon frames may include information about a network provided by the AP, and may indicate available networks provided by the AP. STAs which receive beacon frames may request access to a network provided by the AP. STAs also may send probe request frames to request information about an AP, and the AP may provide the requested information in a probe response frame. APs may send beacons periodically, and the period between respective beacons for a BSS may be referred to as a beacon interval.

The use of multiple BSSIDs allow an AP to transmit one beacon frame or probe response frame (e.g., in response to a probe request sent by a STA) including information intended for STAs in multiple BSSs in a multiple BSSID set. The BSSID of the BSS which transmits a beacon frame or probe response frame may be referred to as a transmitted BSSID, and the BSSIDs of any BSSs which do not transmit a beacon or probe response frame may be referred to as non-transmitted BSSIDs. The STAs in a multiple BSSID set may be aware of other BSSs provided by the AP because of the information included in the beacon frame or probe response frame. For example, because one physical AP may have multiple virtual APs, to communicate with more than one of the BSSs associated with a virtual AP, the physical AP may use one virtual AP to transmit to multiple virtual APs. The BSSID of the transmitting virtual AP may be referred to as the transmitted BSSID, and the BSSIDs of any virtual APs associated with the same AP as the transmitted BSSID and are addressed by another virtual (e.g., the transmitted BSSID) may be referred to as the non-transmitted BSSIDs.

A STA may enter a power saving mode until a time when the AP indicates that traffic is ready to be sent to the STA. A beacon frame or probe response frame may include a different delivery traffic indication map (DTIM) which indicates whether traffic is buffered at the AP for a BSS. In a non-transmitted BSSID beacon frame or probe response, a multiple BSSID-index element may be included in a non-transmitted BSSID profile. In the multiple BSSID-index, any corresponding BSS with a non-transmitted BSSID may indicate a DTIM period based on a target beacon transmission time (TBTT) of BSS with transmitted BSSID. The TBTT of a BSS may be indicated by a beacon frame. If a BSS with a non-transmitted BSSID does not indicate a different DTIM period, then the BSS with a non-transmitted BSSID may follow the DTIM period of the BSS with a transmitted BSSID. A group-addressed buffered unit of the AP may be indicated for any BSS by a TIM element with a corresponding address identifier (AID) index set to the BSSID index of a BSS in the multiple BSSID set. A group-addressed buffered unit indicated by the TIM element of a beacon frame may be delivered separately after the beacon frame (e.g., in a multicast transmission). A TIM element included in a beacon frame may indicate a DTIM period, which may refer to an interval between consecutive target beacon transmission times of beacons which include a DTIM.

During a beacon interval, the AP may send multicast transmissions intended for any STAs in a BSS of a multiple BSSID set. However, to send multicast transmissions to multiple BSSs, an AP either may transmit to only one BSS during a beacon interval, or may transmit to multiple BSSs during a beacon interval. To transmit to only one BSS during a beacon interval, any respective beacon may need to identify the BSS to which the multicast transmission during the subsequent beacon interval is intended. In this manner, the intended BSS may remain active (e.g., an awake or regular power mode) to listen for the multicast transmission, and the other BSSs may ignore transmissions from the AP during the beacon interval (e.g., the other BSSs may use a low-power/power save mode). Transmitting to only one BSS during a beacon interval when there are multiple BSSs in a set may require the transmission of multiple beacon frames over a period of time to complete all multicast transmissions for multiple BSSs. For example, if a multiple BSSID set includes four BSSs, an AP with multicast transmissions for all four BSSs may require four beacon frames and four beacon intervals to complete all four multicast transmissions. If a beacon interval for a BSS is 250 milliseconds, for example, then the AP may need to send multiple beacon frames and use multiple beacon intervals of 250 milliseconds to complete multiple multicast transmissions to a multiple BSSID set.

To transmit to multiple BSSs during a beacon interval, an AP may overlap the beacon intervals of multiple BSSs in a set by using virtual APs, resulting in the transmission of multiple beacons during a 250 millisecond interval. Because the DTIM for a BSS may be the respective beacon interval for the BSS, then a BSS may need to be awake to receive and process beacon frames and multicast transmissions for other BSSs. The STAs of the respective BSSs may need to remain awake/active for the duration of a beacon interval and may need to process each multicast transmission to determine whether the multicast transmission is intended for the BSS. Such may require power and processing use which may be reduced with an enhanced method, and may require an AP to withhold transmissions related to other important services (e.g., voice services or other types of services) until all group-addressed buffered units are transmitted in multicast transmissions.

To address these issues, an AP may alternate the multicast transmissions of group-addressed buffered units for respective BSSs by providing an indication of a DTIM interval in a beacon frame or probe response frame. For example, a beacon frame or probe response frame may be addressed to multiple BSSs in a multiple BSSID set, and may indicate a DTIM interval for a respective BSS corresponding to the beacon interval. Such may require multiple beacon intervals to deliver multiple multicast transmissions of buffered units to multiple BSSs. To reduce the number of beacon intervals to complete multicast transmissions to multiple BSSs in a multiple BSSID set, an AP may send multiple beacons (e.g., a respective beacon for any BSS) during a beacon interval (e.g., multiple overlapping beacon intervals for respective BSS multicast transmissions). Such may require more beacon frames to be sent during a beacon interval (e.g., 250 milliseconds or another time).

Wireless devices therefore may benefit from an enhanced method of communication between APs and multiple BSSs of a multiple BSSID set which may result in a reduced number of transmissions during a given time period and a reduce amount of time that any devices may need to remain active during the time period.

Example embodiments of the present disclosure relate to systems, methods, and devices for group-addressed transmissions to a multiple BSSID set.

In one or more embodiments, an enhanced method may allow for multiple multicast transmissions to respective BSSs of a multiple BSSID set during a time period without the devices of each BSS having to be awake during the entire time period. For example, an AP may indicate to the STAs in any BSS the time during a beacon interval when a multicast transmission is expected for a respective BSS. Only one beacon frame may be required during a beacon interval, and the STAs of a respective BSS may be informed of when to listen for a multicast transmission and when the devices may ignore transmissions during the beacon interval. In this manner, service interruptions may be reduced by enabling multicast group transmissions to be transmitted at any time during the beacon interval, resulting in less time required for an AP to complete multiple multicast transmissions to different BSSs.

In one or more embodiments, a beacon frame or probe response frame may indicate one or more offset times during the beacon interval. An offset time may refer to a target time during a beacon interval when a transmission is intended for a BSS. The default value of an offset time may be zero (e.g., the start of the beacon interval) if no offset time indication is included in a beacon frame or probe response frame, or the offset time may be greater than zero. The offset time may indicate how much time a BSS may wait during a beacon interval before listening for a transmission. The offset time may be included in a new frame element (e.g., an element not currently defined by the IEEE 802.11 technical specification beacon frame or probe response frame). For example, the offset time may be included in a new element which may be part of a non-transmitted BSSID profile. The target time for a BSS may be a TBTT of a DTIM for the BSS (e.g., as indicated by a beacon frame) plus an indicated offset time. An STA in a BSS may process a beacon DTIM to determine whether there are buffered group-addressed units for the STA's associated BSS during a DTIM interval, and may listen for the group-addressed traffic at the target time.

In one or more embodiments, the offset for a target time may be overloaded on a TIM broadcast transmission. TIM broadcasts may occur during a beacon interval and may be independent of a beacon frame. TIM frames may indicate traffic addressed to a BSS indicated by the TIM, and a time for the group-addressed transmission. A TIM frame may include significantly less information than a beacon frame, and therefore may be a shorter frame in duration. For example, a beacon frame may include information for multiple BSSs in a multiple BSSID set, and a TIM frame may include information for a single BSS. A TIM frame may indicate buffered group-addressed frames with a TIM bitmap bit. The bit may be reserved for all BSSIDs in a multiple BSSID set, but may be unreserved to indicate a offset for a target time for a transmission intended for a BSS. An AP may send multiple TIM frames during a beacon interval, and because TIM frames may be significantly lighter broadcasts than beacons, an AP may reduce the amount of overhead used to indicate multiple offsets for multiple BSSs during a beacon interval.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

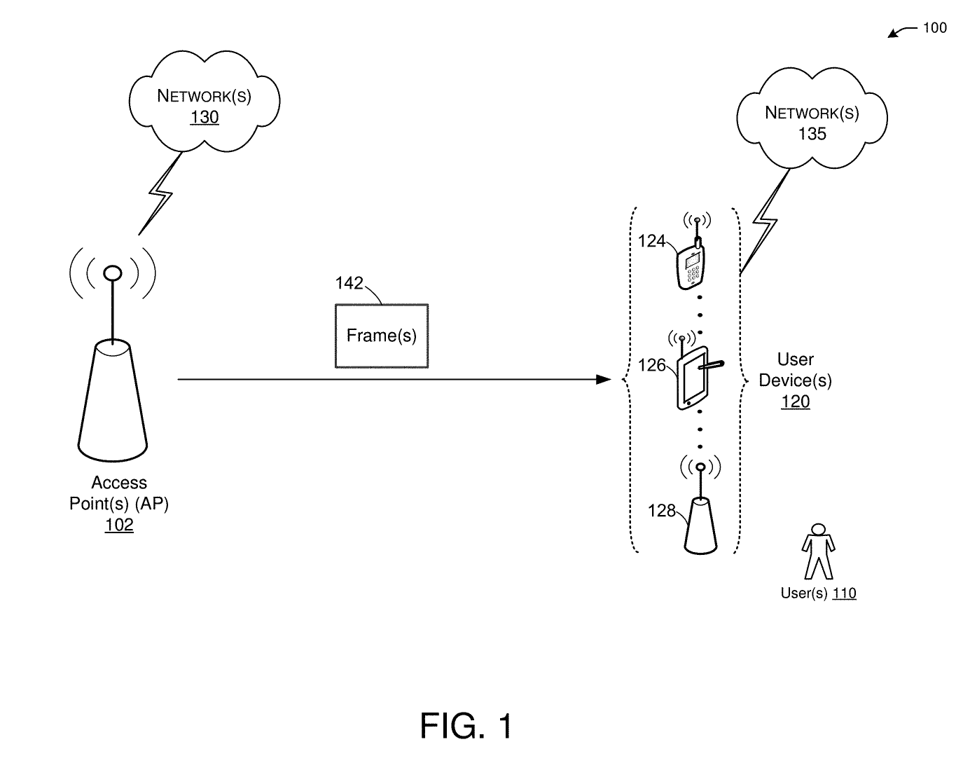

FIG. 1 is a network diagram illustrating an example network environment, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

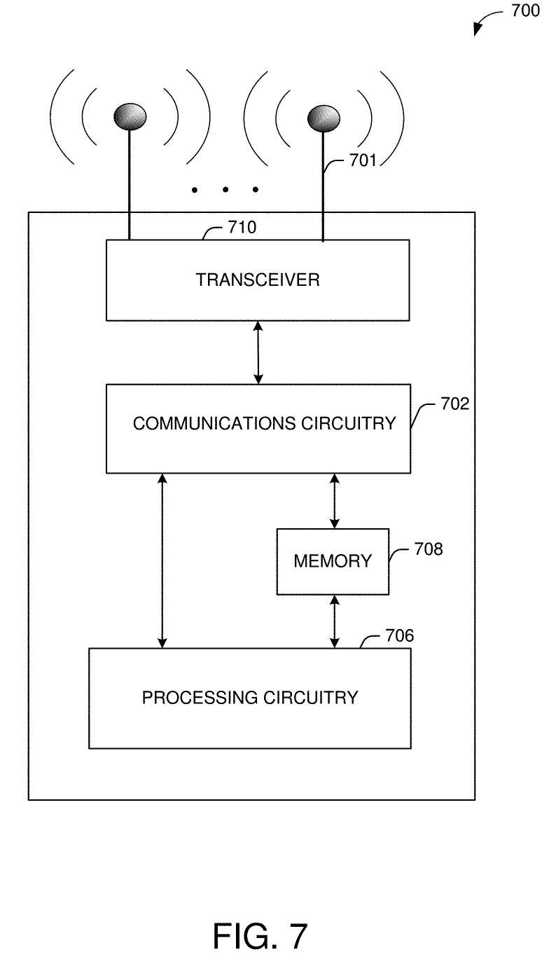

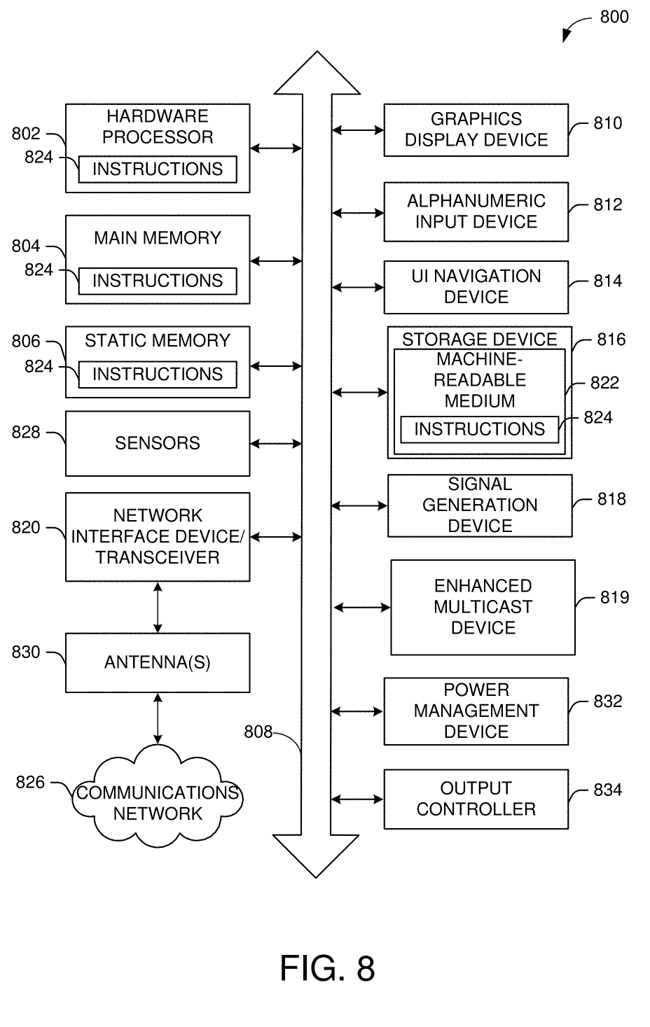

In some embodiments, the user devices 120 and the AP 102 may include one or more computer systems similar to that of the functional diagram of FIG. 7 and/or the example machine/system of FIG. 8.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static, device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile Internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (AID) converter, one or more buffers, and digital baseband.

In one embodiment, and with reference to FIG. 1, AP 102 may communicate with one or more user devices 120. The AP 102 and the user devices 120 may exchange one or more frames 142. The one or more frames 142 may include beacon frames, probe request and probe response frames, multicast group-addressed transmissions, flexible multicast service (FMS) frames, TIM frames, and other frames associated with multi-BSSID set transmissions.

It is understood that the above descriptions are for purposes of illustration and are not meant to be limiting.

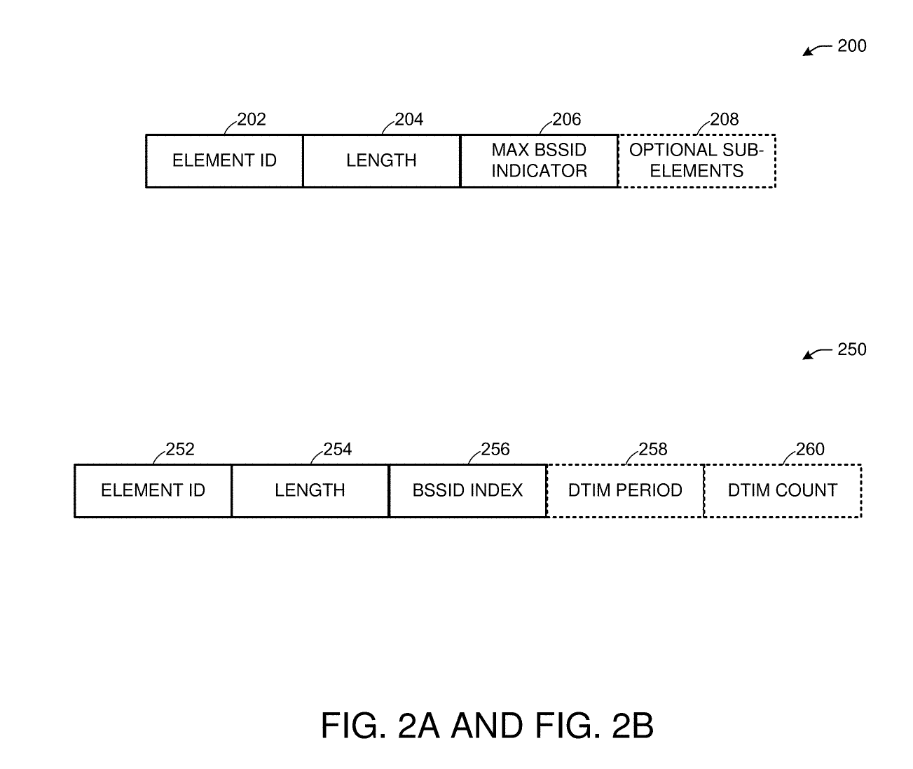

FIG. 2A depicts an illustrative portion 200 of a multiple basic service set (BSS) identifier (BSSID) element format, in accordance with one or more example embodiments of the present disclosure.

Referring to FIG. 2A, the portion 200 may include one or more fields such as an element identifier (element ID) 202, a length 204, a maximum BSSID indicator (Max BSSID indicator) 206, and one or more optional sub-elements 208. The length of the element ID 202 may be one octet. The length of the length 204 field may be one octet. The length of the Max BSSID indicator 206 may be one octet. The length of the one or more optional sub-elements may be variable. The portion 200 may be included in a beacon frame or a probe response frame sent by an AP (e.g., AP 102 of FIG. 1).

The element ID 202 may include a service set identifier (SSID), BSS membership selectors, parameter sets, a TIM, and other information. A TIM may include a DTIM count, a DTIM period, and bitmap details. The DTIM count may indicate how many beacon frames, including a beacon frame which includes the TIM, may appear before the next DTIM. The DTIM period may indicate the number of beacon intervals between successive DTIMs. Bits of the bitmap details may correspond to buffered traffic for a STA in a BSS. When a STA receives a beacon or probe response frame with the portion 200, the STA may determine when traffic is buffered at an AP for the STA, and when to expect another DTIM. The length 204 field may indicate the length of the portion 200. The Max BSSID indicator 206 may indicate the maximum number of BSSIDs are allowed in a multiple BSSID set.

When the portion 200 is included in a beacon frame or probe response frame, a reference BSSID may be the BSSID of the frame. More than one multiple BSSID elements may be included in a beacon frame.

The one or more optional sub-elements 208 are shown below in Table 1.

TABLE 1
Optional Sub-Elements:

| Sub-Element ID | Name |
|---|---|
| 0 | Non-transmitted BSSID |
| | Profile |
| 1-220 | Reserved |
| 221 | Customizable |
| 222-225 | Reserved |

The non-transmitted BSSID profile sub-element may include a list of elements for one or more APs or STAs having non-transmitted BSSIDs.

A multiple BSSID element in a frame may allow an AP to transmit a single beacon frame or probe response frame with information for multiple BSSs in a multiple BSSID set.

FIG. 2B depicts an illustrative portion 250 of a multiple BSSID-Index element format, in accordance with one or more example embodiments of the present disclosure.

Referring to FIG. 2B, the portion 250 may include one or more fields such as an element ID 252, a length 254, a BSSID index 256, an optional DTIM period 258, and an optional DTIM count 260. The element ID 252 may include a service set identifier (SSID), BSS membership selectors, parameter sets, a TIM, and other information. A TIM may include a DTIM count, a DTIM period, and bitmap details. The DTIM count may indicate how many beacon frames, including a beacon frame which includes the TIM, may appear before the next DTIM. The DTIM period may indicate the number of beacon intervals between successive DTIMs. Bits of the bitmap details may correspond to buffered traffic for a STA in a BSS. When a STA receives a beacon or probe response frame with the portion 200, the STA may determine when traffic is buffered at an AP for the STA, and when to expect another DTIM. The length 204 field may indicate the length of the portion 200. The BSSID index 256 may identify a non-transmitted BSSID. The DTIM period 258 may indicate a DTIM period for a BSSID indicated by the BSSID index 256. The DTIM count 260 may indicate the DTIM count for the BSSID indicated by the BSSID index 256. The portion 250 may be included in a non-transmitted BSSID profile element of a beacon frame or a probe response frame.

For a non-transmitted BSSID, a multiple BSSID-index (e.g., the BSSID index 256) may be included in a non-transmitted BSSID profile. A BSS corresponding to the BSSID index 256 may determine the DTIM period 258 based on the TBTT of the BSS with a transmitted BSSID. If the BSS corresponding to the BSSID index 256 of a non-transmitted BSSID does not identify a DTIM period 258, the BSS may follow the DTIM period of a BSS with a transmitted BSSID. The DTIM period 258 may indicate a time period for a BSS to listen for transmissions. The DTIM period 258 and the DTIM count 260 may be included in a beacon frame, and may be excluded from a probe response frame.

The portion 250 may indicate which beacon interval is used for a BSS in a multiple BSSID set. The portion 250 may indicate that an AP has buffered units for a BSS by including a TIM element with a corresponding access identifier (AID) index equal to a BSSID index of a BSS in the multiple BSSID set. The group-addressed traffic indicated by the TIM element may be delivered after a beacon frame is sent by the AP.

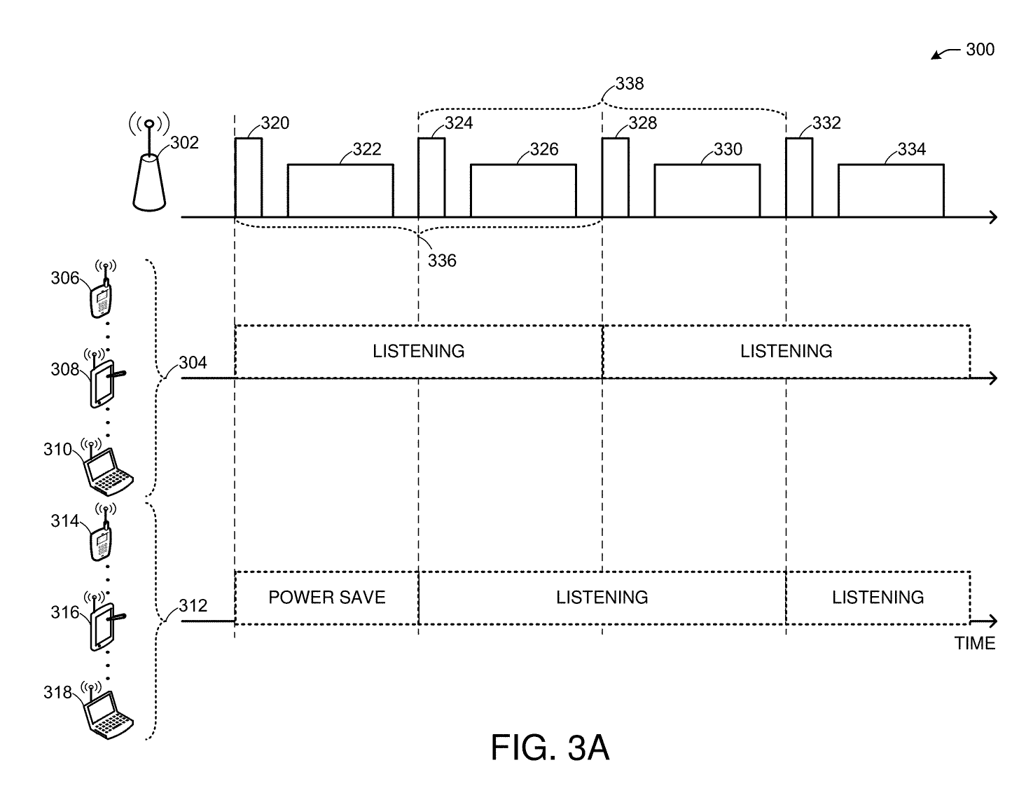

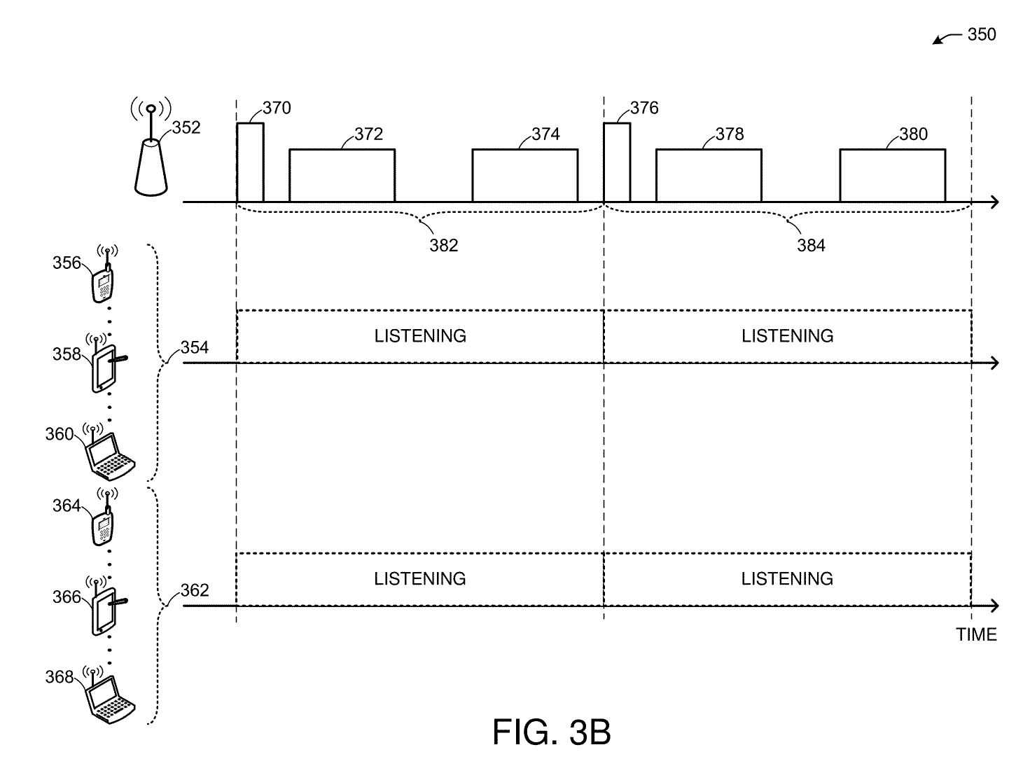

FIG. 3A depicts an illustrative schematic diagram 300 of a multiple BSSID set, in accordance with one or more example embodiments of the present disclosure.

Referring to FIG. 3A, a multiple BSSID set may include an AP 302, a first BSS 304, which may include one or more STAs (e.g., STA 306, STA 308, STA 310), and a second BSS 312, which may include one or more STAs (e.g., STA 314, STA 316, STA 318).

Still referring to FIG. 3A, the AP may send a beacon frame 320, followed by a multicast transmission 322 for the first BSS 304, a beacon frame 324, a multicast transmission 326 for the second BSS 312, a beacon frame 328, a multicast transmission 330 for the first BSS 304, a beacon frame 332, a multicast transmission 334 for the second BSS 312, and so on. The time between the beacon frame 320 and the beacon frame 328 may be beacon interval 336, and the time between the beacon frame 324 and the beacon frame 332 may be beacon interval 338.

The DTIM period (e.g., as indicated by the DTIM period 258 of FIG. 2) may correspond to a TBTT. The transmissions of the respective beacons may be addressed to a respective BSS (e.g., beacon frame 320 and beacon frame 328 may be addressed to the first BSS 304, and beacon frame 324 and beacon frame 332 may be addressed to the second BSS 312), and may indicate that the respective multicast transmissions are intended for a respective BSS (e.g., beacon frame 320 may indicate that multicast transmission 322 is intended for the first BSS 304, beacon frame 328 may indicate that multicast transmission 330 is intended for the first BSS 304, beacon frame 324 may indicate that multicast transmission 326 is intended for the second BSS 312, and beacon frame 332 may indicate that multicast transmission 334 is intended for the second BSS 312). The respective BSSs may determine when to listen during a beacon interval or when they may enter a power save mode. For example, the first BSS 304 may determine, based on beacon frame 320, that the STAs in the first BSS 304 should listen during the beacon interval 336, and the second BSS 312 may determine, based on the beacon frame 320 and the beacon frame 324, that the STAs in the second BSS 312 may enter a power save mode before the beacon interval 338, and should listen during the beacon interval 338.

If the beacon interval 336 is 250 milliseconds, for example, then the AP 302 may have to send multiple beacons (e.g., beacon frame 320 and beacon frame 324) during the 250 millisecond interval to indicate multicast transmissions available for the first BSS 304 and second BSS 312 of the multiple BSSID set.

FIG. 3B depicts an illustrative schematic diagram 350 of a multiple BSSID set, in accordance with one or more example embodiments of the present disclosure.

Referring to FIG. 3B, a multiple BSSID set may include an AP 352, a first BSS 354, which may include one or more STAs (e.g., STA 356, STA 358, STA 360), and a second BSS 362, which may include one or more STAs (e.g., STA 364, STA 366, STA 368).

Still referring to FIG. 3B, the AP 352 may send a beacon frame 370, followed by a multicast transmission 372 for the first BSS 354, a multicast transmission for the second BSS 362, a beacon frame 376, a multicast transmission 378 for the first BSS 354, a multicast transmission 380 for the second BSS 362, and so on. The time between the beacon frame 370 and the beacon frame 376 may be beacon interval 382, and the time between the beacon frame 376 and a subsequent beacon (not shown) may be beacon interval 384.

The AP 352 may reduce the number of beacons to transmit from the example shown in FIG. 3A by transmitting multiple multicast transmissions during a single beacon interval. However, without an indication of when the multicast transmissions may be expected during a beacon interval, the first BSS 354 and the second BSS 362 may need to listen for an entire beacon interval even though only a portion of a beacon interval may be used to send a multicast transmission to a respective BSS. Because the AP 352 may prioritize multicast group transmissions (e.g., multicast transmission 372, multicast transmission 374, multicast transmission 378, multicast transmission 380) over other types of transmissions, the AP 352 may need to complete all multicast transmissions before providing other critical services, so the first BSS 354 and the second BSS 362 may need to wait until all multicast transmissions during a beacon interval are complete before receiving important information from the AP 352.

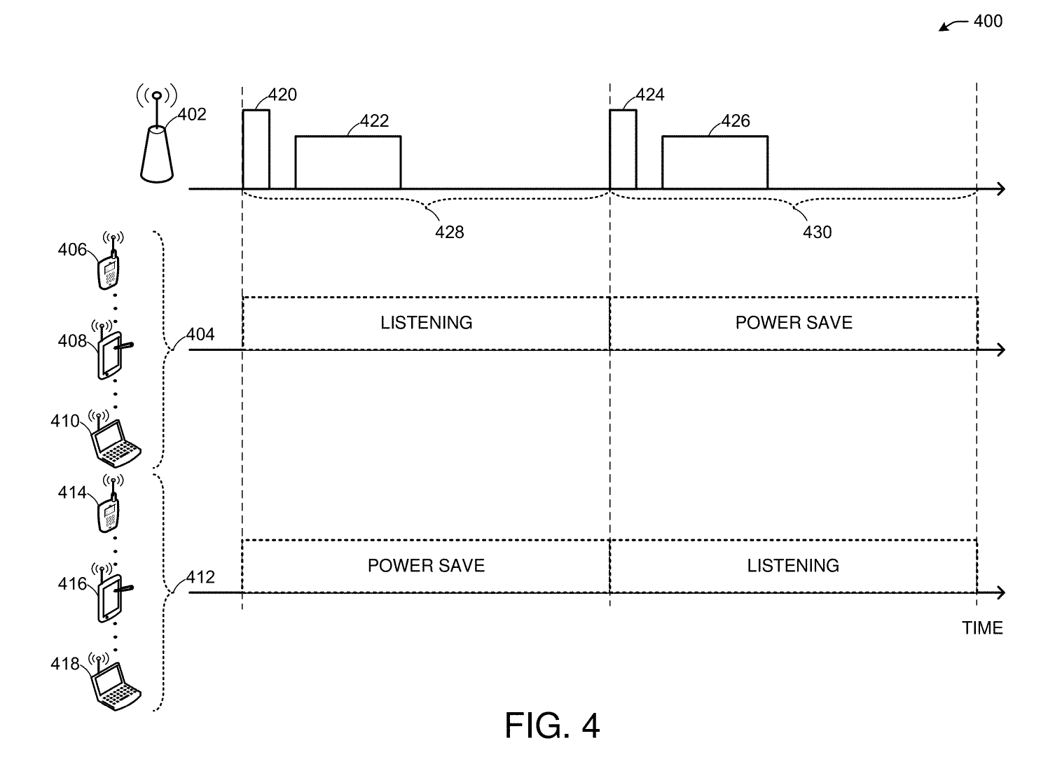

FIG. 4 depicts an illustrative schematic diagram 400 of a multiple BSSID set, in accordance with one or more example embodiments of the present disclosure.

Referring to FIG. 4, a multiple BSSID set may include an AP 402, a first BSS 404, which may include one or more STAs (e.g., STA 406, STA 408, STA 410), and a second BSS 412, which may include one or more STAs (e.g., STA 414, STA 416, STA 418).

Still referring to FIG. 4, the AP 402 may send a beacon 420, followed by a multicast transmission for the first BSS 404, a beacon 424, and a multicast transmission for the second BSS 412. The time between the beacon 420 and the beacon 424 may be beacon interval 428, and the time between the beacon 424 and a subsequent beacon (not shown) may be beacon interval 430.

The beacon 420 may indicate a DTIM interval for the first BSS 404, allowing the first BSS 404 to determine to listen during the beacon interval 428 for the multicast transmission 422. The second BSS 412 may determine to enter a power save mode during the beacon interval 428 based on the DTIM indicated for the first BSS 404 by the beacon 420.

Using the example beacon interval of 250 milliseconds, the AP 402 may have to use multiple 250 millisecond intervals (e.g., 500 milliseconds or more) to complete the multicast transmission 422 and the multicast transmission 426, and may have to send multiple beacons (e.g., beacon 420, beacon 424) to complete the multicast transmission 422 and the multicast transmission 426. If the AP 402 shortened the beacon interval 428 and the beacon interval 430 (e.g., by half to 125 milliseconds), the AP 402 may send multiple beacons (e.g., beacon 420, beacon 424) during the same 250 millisecond time period to complete the multicast transmission 422 and the multicast transmission 426.

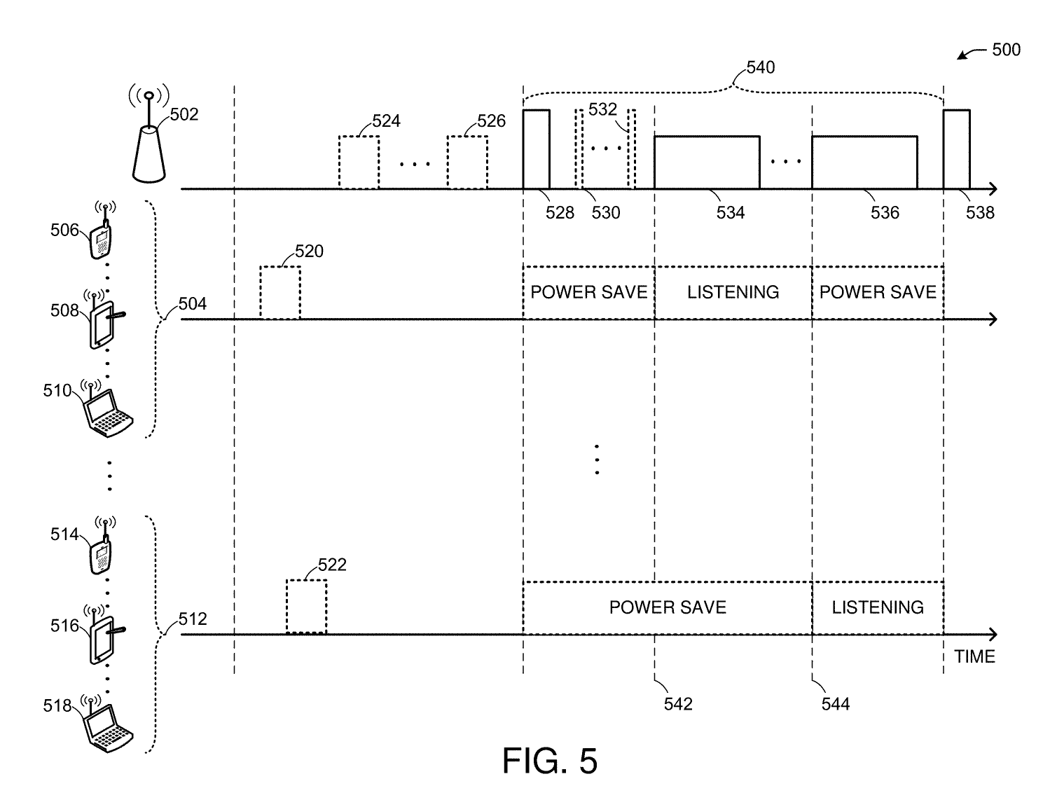

FIG. 5 depicts an illustrative schematic diagram 500 of a multiple BSSID set, in accordance with one or more example embodiments of the present disclosure.

Referring to FIG. 5, a multiple BSSID set may include an AP 502, a first BSS 504, which may include one or more STAs (e.g., STA 506, STA 508, STA 510), and a second BSS 512, which may include one or more STAs (e.g., STA 514, STA 516, STA 518).

Still referring to FIG. 5, the respective BSSs may send one or more frames (e.g., the first BSS 504 may send frame 520, and/or the second BSS may send frame 522) to the AP 502 in respective uplink transmissions. The frame 520 and/or the frame 522 may be probe request frames. The AP 502 may respond to the frame 520 and/or the frame 522 with one or more response frames (e.g., frame 524, frame 526), which may be probe response frames sent in response to respective probe request frames. The frame 520 and/or the frame 522 may include a non-transmitted BSSID profile (e.g., included in the optional sub-elements 208 of FIG. 2). The AP 502 may send a beacon frame 528, optional TIM frames (e.g., TIM frame 530, TIM frame 532) for respective BSSs, a multicast transmission 534, a multicast transmission 536, a beacon frame 538, and so on. The time between the beacon frame 528 and the beacon frame 538 may refer to a beacon interval 540.

In one or more embodiments, the AP 502 may indicate the times when the respective BSSs should listen for respective multicast transmissions. For example, the AP 502 may indicate to the first BSS 504 that the first BSS 504 should listen for the multicast transmission 534 at time 542, and may indicate to the second BSS 512 that the second BSS 512 should listen for the multicast transmission 536 at time 544. The second BSS 512 may remain in a power save mode until time 544, and the first BSS 504 may remain in a power save mode until time 542 and beginning at time 544. In a power save mode, the respective BSSs may ignore transmissions. By indicating the time 542 and the time 544 within the beacon interval, the AP 502 may provide multiple multicast transmissions during one beacon interval without requiring multiple beacons during that time. For example, if the beacon interval 540 is 250 milliseconds, then multiple multicast transmissions (e.g., multicast transmission 534, multicast transmission 536) may be completed during the beacon interval 540 without the AP 502 needing to send multiple beacons (e.g., such as in FIG. 3A). To indicate the time 542 and the time 544 (e.g., an offset time from the time of the beacon frame 528, corresponding to a respective target time for a respective BSS to listen for a multicast transmission), the multiple BSSID set may use one of multiple options.

In one or more embodiments, an option for indicating the time 542 and the time 544 may include using the beacon frame 528 to communicate the offset times. The offset times may use a default value (e.g., 0), or may be included in a new element included in a non-transmitted BSSID profile (e.g., included in the one or more optional sub-elements 208 of FIG. 2), or in another portion of the beacon frame 528. The TBTT of a DTIM for a BSS plus the indicated offset time as indicated by the beacon frame 528 may indicate the target time (e.g., time 542, time 544). The STAs of a BSS may evaluate a DTIM beacon and determine whether the AP 502 has group-addressed buffered traffic (e.g., multicast transmission 534, multicast transmission 536) for the BSS during the indicated DTIM interval (e.g., based on the DTIM period 258 of FIG. 2B).

In one or more embodiments, an option for indicating the time 542 and the time 544 may include using individual TIM frames (e.g., TIM frame 530, TIM frame 532). The time 542 and/or the time 544 may be overloaded on a TIM broadcast transmission. TIM frames may include TIM information of a beacon frame, but may be shorter in length because a TIM frame may include the TIM information for a single BSS rather than for all BSSs in a multiple BSSID set. TIM frames may have a reserved bit which may be unreserved to indicate the time 542 or the time 544. Multiple TIM frames may be sent during the beacon interval 540. For example, TIM frame 530 may be addressed to the first BSS 504 and may indicate the time 542 for the first BSS 504 to listen for the multicast transmission 534. TIM frame 530 may be addressed to the second BSS 512 and may indicate the time 544 for the second BSS 512 to listen for the multicast transmission 536. In this manner, the BSSs may not need to listen for the entirety of the beacon interval 540 and may use a power save mode during at least a portion of the beacon interval 540. A flexible multicast service (FMS) process may be used to indicate the time 542 and the time 544. For example, FMS frames (e.g., frame 524, frame 526) may indicate a transmission interval based on a TIM transmission interval, by using an FMS counter field or another field in an FMS frame. A flow identifier of a broadcast TWT negotiation may map to a FMS identifier (FMSID), which may be included in a TWT element, allowing one flow identifier to be used for multiple FMSIDs.

It is understood that the above descriptions are for purposes of illustration and are not meant to be limiting.

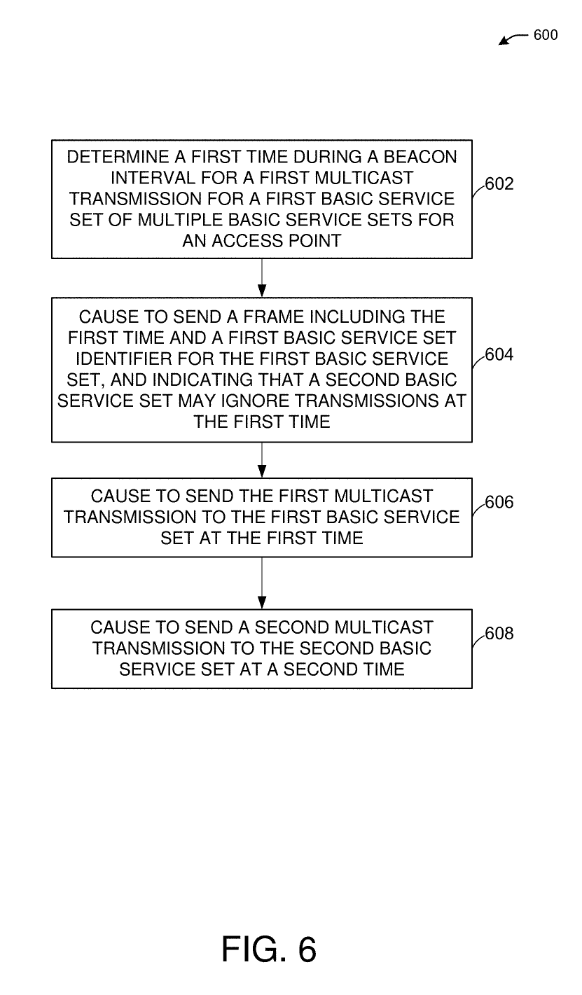

FIG. 6 illustrates a flow diagram of illustrative process for enhanced distribution of group-addressed transmissions for a multiple BSSID set, in accordance with one or more example embodiments of the present disclosure.

At block 602, a device (e.g., the AP 102 of FIG. 1) may determine a first time (e.g., time 542 of FIG. 5) during a beacon interval (e.g., beacon interval 540 of FIG. 5) for a first multicast transmission (e.g., multicast transmission 534 of FIG. 5) for a first BSS (e.g., first BSS 504 of FIG. 5) of a multiple BSSID set for the device. The first time may be based on a TBTT of a DTIM for the first BSS, plus an offset time. The device may determine a second time (e.g., time 544 of FIG. 5) during the beacon interval for a second multicast transmission (e.g., multicast transmission 536 of FIG. 5) for a second BSS (e.g., second BSS 512 of FIG. 5) of the multiple BSSID set. The second time may be based on a TBTT of a DTIM for the second BSS, plus an offset time. The first time may be based on a first service period (e.g., a period of time when the device may send frames to devices in a BSS) of a broadcast TWT (e.g., a time when a STA has been instructed by the device, using information in a beacon, to be awake to receive transmissions from the device), and the second time may be based on a second service period of the broadcast TWT. The first and second services periods may be based on respective flow identifiers indicated by a broadcast TWT. The first time and the second time may be different or the same.

At block 604, the device may send a frame including the first time and a BSSID for the first BSS. The frame may indicate to another BSS (e.g., second BSS 512 of FIG. 5) that the other BSS may ignore transmissions at the first time and may use a power save mode at that time. The frame may be a management frame such as a beacon frame (e.g., beacon frame 528 of FIG. 5) or probe response frame (e.g., frame 524, frame 526 of FIG. 5). The frame may include a first element for the first BSS and a second element for the second BSS, and additional elements for any other respective BSSs in a multiple BSSID set. The first element may indicate the offset applied to the first BSS to indicate when, during the beacon interval, the STAs of the first BSS should expect a transmission from the device. The second element may indicate the offset applied to the second BSS to indicate when, during the beacon interval, the STAs of the second BSS should expect a transmission from the device. The frame may include an indication of a non-transmitted BSSID profile, which may include an indication of the first time.

At block 606, the device may send the first multicast transmission (e.g., multicast transmission 534 of FIG. 5) to the first BSS at the first time. At block 608, the device may send a second multicast transmission (e.g., multicast transmission 536 of FIG. 5) to the second BSS at the second time. The device may send multiple multicast and/or unicast transmissions during the beacon interval to any STAs in a BSS associated with the device. The device may send other types of frames, such as TIM frames, during the beacon interval to indicate when a BSS may expect a transmission from the device during the beacon interval. Based on the times and offsets indicated by the device and provided to the STAs of any BSS, the STAs may determine when to listen for transmissions from the device and when the STAs may enter power save modes because no transmissions are expected from the device at a given time.

It is understood that the above descriptions are for purposes of illustration and are not meant to be limiting.

FIG. 7 shows a functional diagram of an exemplary communication station 700 in accordance with some embodiments. In one embodiment, FIG. 7 illustrates a functional block diagram of a communication station that may be suitable for use as an AP 102 (FIG. 1) or user device 120 (FIG. 1) in accordance with some embodiments. The communication station 700 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 700 may include communications circuitry 702 and a transceiver 710 for transmitting and receiving signals to and from other communication stations using one or more antennas 701. The communications circuitry 702 may include circuitry that can operate the physical layer (PHY) communications and/or medium access control (MAC) communications for controlling access to the wireless medium, and/or any other communications layers for transmitting and receiving signals. The communication station 700 may also include processing circuitry 706 and memory 708 arranged to perform the operations described herein. In some embodiments, the communications circuitry 702 and the processing circuitry 706 may be configured to perform operations detailed in FIGS. 1-6.

In accordance with some embodiments, the communications circuitry 702 may be arranged to contend for a wireless medium and configure frames or packets for communicating over the wireless medium. The communications circuitry 702 may be arranged to transmit and receive signals. The communications circuitry 702 may also include circuitry for modulation/demodulation, upconversion/downconversion, filtering, amplification, etc. In some embodiments, the processing circuitry 706 of the communication station 700 may include one or more processors. In other embodiments, two or more antennas 701 may be coupled to the communications circuitry 702 arranged for sending and receiving signals. The memory 708 may store information for configuring the processing circuitry 706 to perform operations for configuring and transmitting message frames and performing the various operations described herein. The memory 708 may include any type of memory, including non-transitory memory, for storing information in a form readable by a machine (e.g., a computer). For example, the memory 708 may include a computer-readable storage device, read-only memory (ROM), random-access memory (RAM), magnetic disk storage media, optical storage media, flash-memory devices and other storage devices and media.

In some embodiments, the communication station 700 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 700 may include one or more antennas 701. The antennas 701 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 700 may include one or more of a keyboard, a display, a non-volatile memory port, multiple antennas, a graphics processor, an application processor, speakers, and other mobile device elements. The display may be an LCD screen including a touch screen.

Although the communication station 700 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 700 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 700 may include one or more processors and may be configured with instructions stored on a computer-readable storage device memory.

FIG. 8 illustrates a block diagram of an example of a machine 800 or system upon which any one or more of the techniques (e.g., methodologies) discussed herein may be performed. In other embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environments. The machine 800 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 800 may include a hardware processor 802 (e.g., a central processing unit (CPU), a graphics processing unit (GPU), a hardware processor core, or any combination thereof), a main memory 704 and a static memory 806, some or all of which may communicate with each other via an interlink (e.g., bus) 808. The machine 800 may further include a power management device 832, a graphics display device 810, an alphanumeric input device 812 (e.g., a keyboard), and a user interface (UI) navigation device 814 (e.g., a mouse). In an example, the graphics display device 810, alphanumeric input device 812, and UI navigation device 814 may be a touch screen display. The machine 800 may additionally include a storage device (i.e., drive unit) 816, a signal generation device 818 (e.g., a speaker), an enhanced multicast device 819, a network interface device/transceiver 820 coupled to antenna(s) 830, and one or more sensors 828, such as a global positioning system (GPS) sensor, a compass, an accelerometer, or other sensor. The machine 800 may include an output controller 834, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 802 for generation and processing of the baseband signals and for controlling operations of the main memory 704, the storage device 816, and/or the enhanced multicast device 819. The baseband processor may be provided on a single radio card, a single chip, or an integrated circuit (IC).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 704, within the static memory 806, or within the hardware processor 802 during execution thereof by the machine 800. In an example, one or any combination of the hardware processor 802, the main memory 704, the static memory 806, or the storage device 816 may constitute machine-readable media.

The enhanced multicast device 819 may carry out or perform any of the operations and processes (e.g., process 600 of FIG. 6) described and shown above.

It is understood that the above are only a subset of what the enhanced multicast device 819 may be configured to perform and that other functions included throughout this disclosure may also be performed by the enhanced multicast device 819.

While the machine-readable medium 822 is illustrated as a single medium, the term “machine-readable medium” may include a single medium or multiple media (e.g., a centralized or distributed database, and/or associated caches and servers) configured to store the one or more instructions 824.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 800 and that cause the machine 800 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device/transceiver 820 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 820 may include one or more physical jacks (e.g., Ethernet, coaxial, or phone jacks) or one or more antennas to connect to the communications network 826. In an example, the network interface device/transceiver 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 800 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Example 1 may be a device comprising memory and processing circuitry configured to: determine a first time associated with a first multicast transmission, wherein the first multicast transmission comprises a first basic service set identifier (BSSID), wherein the first BSSID is associated with a first BSS of a multi-BSSID set comprising the first BSS and a second BSS; cause to send a frame, wherein the frame comprises the first time and the first BSSID, wherein the frame indicates that the second BSS is to ignore multicast transmissions at the first time, and wherein the first time is during a beacon interval associated with a beacon addressed to the multi-BSSID set; cause to send the first multicast transmission at the first time; and cause to send a second multicast transmission at a second time, wherein the second time is during the beacon interval, and wherein the second multicast transmission comprises a second BSSID associated with the second BSS.

Example 2 may include the device of example 1 and/or some other example herein, wherein to determine the first time is based on a target beacon transmission time of a delivery traffic indication map (DTIM) for the first BSS plus a first offset, and wherein the processing circuitry is further configured to determine the second time based on a target beacon transmission time of a DTIM for the second BSS plus a second offset.

Example 3 may include the device of example 2 and/or some other example herein, wherein the frame further comprises a first element associated with the first BSS and a second element associated with the second BSS, wherein the first element indicates the first offset, wherein the second element indicates the second offset.

Example 4 may include the device of example 2 and/or some other example herein, wherein to determine the first time is based on a first service period of a broadcast target wake time (TWT), and wherein to determine the second time is based on a second service period of the broadcast TWT.

Example 5 may include the device of example 4 and/or some other example herein, determine the first service period based on a first flow identifier of the broadcast TWT; and determine the second service period based on a second flow identifier of the broadcast TWT.

Example 6 may include the device of example 1 and/or some other example herein, wherein the frame is a management frame, and wherein the frame further indicates the second time and the second BSS.

Example 7 may include the device of example 1 and/or some other example herein, wherein the first time is different from the second time.

Example 8 may include the device of example 1 and/or some other example herein, wherein the frame indicates a non-transmitted BSS identifier profile, and wherein the non-transmitted BSS identifier profile indicates the first time.

Example 9 may include the device of example 1 and/or some other example herein, further comprising a transceiver configured to transmit and receive wireless signals, wherein the wireless signals comprise the first multicast transmission, the second multicast transmission, and the frame.

Example 10 may include the device of example 9 and/or some other example herein, further comprising one or more antennas coupled to the transceiver.

Example 11 may include a non-transitory computer-readable medium storing computer-executable instructions which when executed by one or more processors result in performing operations comprising: determining a first time associated with a first multicast transmission, wherein the first multicast transmission comprises a first basic service set identifier (BSSID), wherein the first BSSID is associated with a first BSS of a multi-BSSID set comprising the first BSS and a second BSS; causing to send a frame, wherein the frame comprises the first time and the first BSSID, wherein the frame indicates that the second BSS is to ignore multicast transmissions at the first time, and wherein the first time is during a beacon interval associated with a beacon addressed to the multi-BSSID set; causing to send the first multicast transmission at the first time; and causing to send a second multicast transmission at a second time, wherein the second time is during the beacon interval, and wherein the second multicast transmission comprises a second BSSID associated with the second BSS.

Example 12 may include the non-transitory computer-readable medium of example 11 and/or some other example herein, wherein determining the first time is based on a target beacon transmission time of a delivery traffic indication map (DTIM) for the first BSS plus a first offset, the operations further comprising determining the second time based on a target beacon transmission time of a DTIM for the second BSS plus a second offset.

Example 13 may include the non-transitory computer-readable medium of example 12 and/or some other example herein, wherein the frame further comprises a first element associated with the first BSS and a second element associated with the second BSS, wherein the first element indicates the first offset, wherein the second element indicates the second offset.

Example 14 may include the non-transitory computer-readable medium of example 12 and/or some other example herein, wherein determining the first time is based on a first service period of a broadcast target wake time (TWT), and wherein determining the second time is based on a second service period of the broadcast TWT.

Example 15 may include the non-transitory computer-readable medium of example 14 and/or some other example herein, the operations further comprising: determining the first service period based on a first flow identifier of the broadcast TWT; and determining the second service period based on a second flow identifier of the broadcast TWT.

Example 16 may include the non-transitory computer-readable medium of example 11 and/or some other example herein, wherein the frame is a management frame, and wherein the frame further indicates the second time and the second BSS.

Example 17 may include the non-transitory computer-readable medium of example 11 and/or some other example herein, wherein the frame indicates a non-transmitted BSS identifier profile, and wherein the non-transmitted BSS identifier profile indicates the first time.

Example 18 may include the non-transitory computer-readable medium of example 11 and/or some other example herein, wherein the first time is different from the second time.

Example 19 may include a method comprising: determining, by one or more processors of a device, a first time associated with a first multicast transmission, wherein the first multicast transmission comprises a first basic service set identifier (BSSID), wherein the first BSSID is associated with a first BSS of a multi-BSSID set comprising the first BSS and a second BSS; causing to send, by the one or more processors, a frame, wherein the frame comprises the first time and the first BSSID, wherein the frame indicates that the second BSS is to ignore multicast transmissions at the first time, and wherein the first time is during a beacon interval associated with a beacon addressed to the multi-BSSID set; causing to send, by the one or more processors, the first multicast transmission at the first time; and causing to send, by the one or more processors, a second multicast transmission at a second time, wherein the second time is during the beacon interval, and wherein the second multicast transmission comprises a second BSSID associated with the second BSS.

Example 20 may include the method of example 19 and/or some other example herein, wherein determining the first time is based on a target beacon transmission time of a delivery traffic indication map (DTIM) for the first BSS plus a first offset, the method further comprising determining the second time based on a target beacon transmission time of a DTIM for the second BSS plus a second offset.

Example 21 may include an apparatus comprising means for: determining a first time associated with a first multicast transmission, wherein the first multicast transmission comprises a first basic service set identifier (BSSID), wherein the first BSSID is associated with a first BSS of a multi-BSSID set comprising the first BSS and a second BSS; causing to send a frame, wherein the frame comprises the first time and the first BSSID, wherein the frame indicates that the second BSS is to ignore multicast transmissions at the first time, and wherein the first time is during a beacon interval associated with a beacon addressed to the multi-BSSID set; causing to send the first multicast transmission at the first time; and causing to send a second multicast transmission at a second time, wherein the second time is during the beacon interval, and wherein the second multicast transmission comprises a second BSSID associated with the second BSS.

Example 22 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 23 may include an apparatus comprising logic, modules, and/or circuitry to perform one or more elements of a method described in or related to any of examples 1-21, or any other method or process described herein.

Example 24 may include a method, technique, or process as described in or related to any of examples 1-21, or portions or parts thereof.

Example 25 may include an apparatus comprising: one or more processors and one or more computer readable media comprising instructions that, when executed by the one or more processors, cause the one or more processors to perform the method, techniques, or process as described in or related to any of examples 1-21, or portions thereof.

Example 26 may include a method of communicating in a wireless network as shown and described herein.

Example 27 may include a system for providing wireless communication as shown and described herein.

Example 28 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

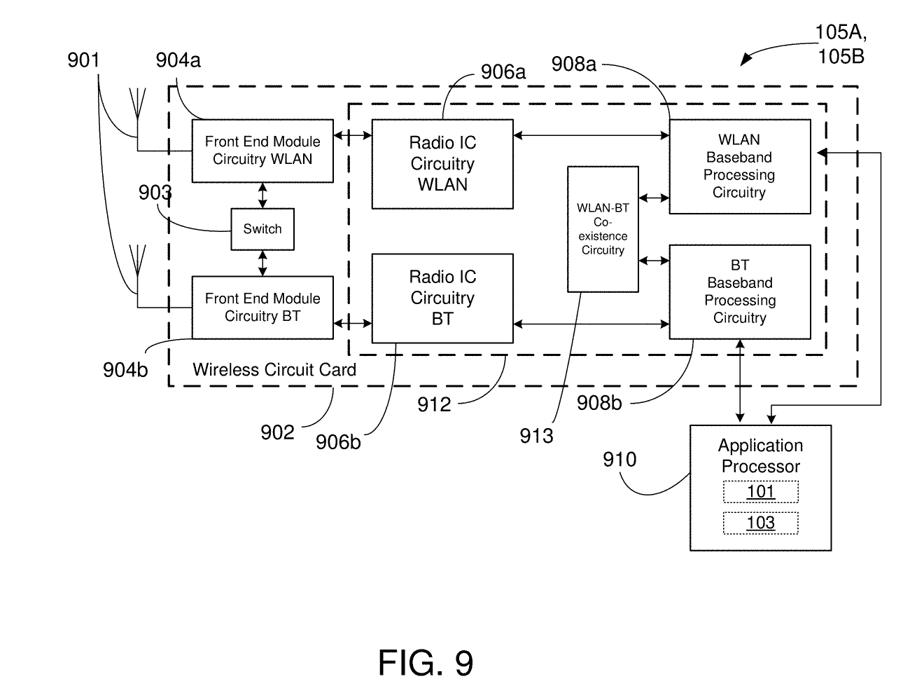

FIG. 9 is a block diagram of a radio architecture 105A, 105B in accordance with some embodiments that may be implemented in any one of the example AP 102 and/or the example user device(s)120 of FIG. 1. Radio architecture 105A, 105B may include radio front-end module (FEM) circuitry 904a-b, radio IC circuitry 906a-b and baseband processing circuitry 908a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 904a-b may include a WLAN or Wi-Fi FEM circuitry 904a and a Bluetooth (BT) FEM circuitry 904b. The WLAN FEM circuitry 904a may include a receive signal path comprising circuitry configured to operate on WLAN RF signals received from one or more antennas 901, to amplify the received signals and to provide the amplified versions of the received signals to the WLAN radio IC circuitry 906a for further processing. The BT FEM circuitry 904b may include a receive signal path which may include circuitry configured to operate on BT RF signals received from one or more antennas 901, to amplify the received signals and to provide the amplified versions of the received signals to the BT radio IC circuitry 906b for further processing. FEM circuitry 904a may also include a transmit signal path which may include circuitry configured to amplify WLAN signals provided by the radio IC circuitry 906a for wireless transmission by one or more of the antennas 901. In addition, FEM circuitry 904b may also include a transmit signal path which may include circuitry configured to amplify BT signals provided by the radio IC circuitry 906b for wireless transmission by the one or more antennas. In the embodiment of FIG. 9, although FEM 904a and FEM 904b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 906a-b as shown may include WLAN radio IC circuitry 906a and BT radio IC circuitry 906b. The WLAN radio IC circuitry 906a may include a receive signal path which may include circuitry to down-convert WLAN RF signals received from the FEM circuitry 904a and provide baseband signals to WLAN baseband processing circuitry 908a. BT radio IC circuitry 906b may in turn include a receive signal path which may include circuitry to down-convert BT RF signals received from the FEM circuitry 904b and provide baseband signals to BT baseband processing circuitry 908b. WLAN radio IC circuitry 906a may also include a transmit signal path which may include circuitry to up-convert WLAN baseband signals provided by the WLAN baseband processing circuitry 908a and provide WLAN RF output signals to the FEM circuitry 904a for subsequent wireless transmission by the one or more antennas 901. BT radio IC circuitry 906b may also include a transmit signal path which may include circuitry to up-convert BT baseband signals provided by the BT baseband processing circuitry 908b and provide BT RF output signals to the FEM circuitry 904b for subsequent wireless transmission by the one or more antennas 901. In the embodiment of FIG. 9, although radio IC circuitries 906a and 906b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 908a-b may include a WLAN baseband processing circuitry 908a and a BT baseband processing circuitry 908b. The WLAN baseband processing circuitry 908a may include a memory, such as, for example, a set of RAM arrays in a Fast Fourier Transform or Inverse Fast Fourier Transform block (not shown) of the WLAN baseband processing circuitry 908a. Each of the WLAN baseband circuitry 908a and the BT baseband circuitry 908b may further include one or more processors and control logic to process the signals received from the corresponding WLAN or BT receive signal path of the radio IC circuitry 906a-b, and to also generate corresponding WLAN or BT baseband signals for the transmit signal path of the radio IC circuitry 906a-b. Each of the baseband processing circuitries 908a and 908b may further include physical layer (PHY) and medium access control layer (MAC) circuitry, and may further interface with a device for generation and processing of the baseband signals and for controlling operations of the radio IC circuitry 906a-b.

Referring still to FIG. 9, according to the shown embodiment, WLAN-BT coexistence circuitry 913 may include logic providing an interface between the WLAN baseband circuitry 908a and the BT baseband circuitry 908b to enable use cases requiring WLAN and BT coexistence. In addition, a switch 903 may be provided between the WLAN FEM circuitry 904a and the BT FEM circuitry 904b to allow switching between the WLAN and BT radios according to application needs. In addition, although the antennas 901 are depicted as being respectively connected to the WLAN FEM circuitry 904a and the BT FEM circuitry 904b, embodiments include within their scope the sharing of one or more antennas as between the WLAN and BT FEMs, or the provision of more than one antenna connected to each of FEM 904a or 904b.

In some embodiments, the front-end module circuitry 904a-b, the radio IC circuitry 906a-b, and baseband processing circuitry 908a-b may be provided on a single radio card, such as wireless radio card 902. In some other embodiments, the one or more antennas 901, the FEM circuitry 904a-b and the radio IC circuitry 906a-b may be provided on a single radio card. In some other embodiments, the radio IC circuitry 906a-b and the baseband processing circuitry 908a-b may be provided on a single chip or integrated circuit (IC), such as IC 912.

In some embodiments, the wireless radio card 902 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, the BT baseband circuitry 908b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

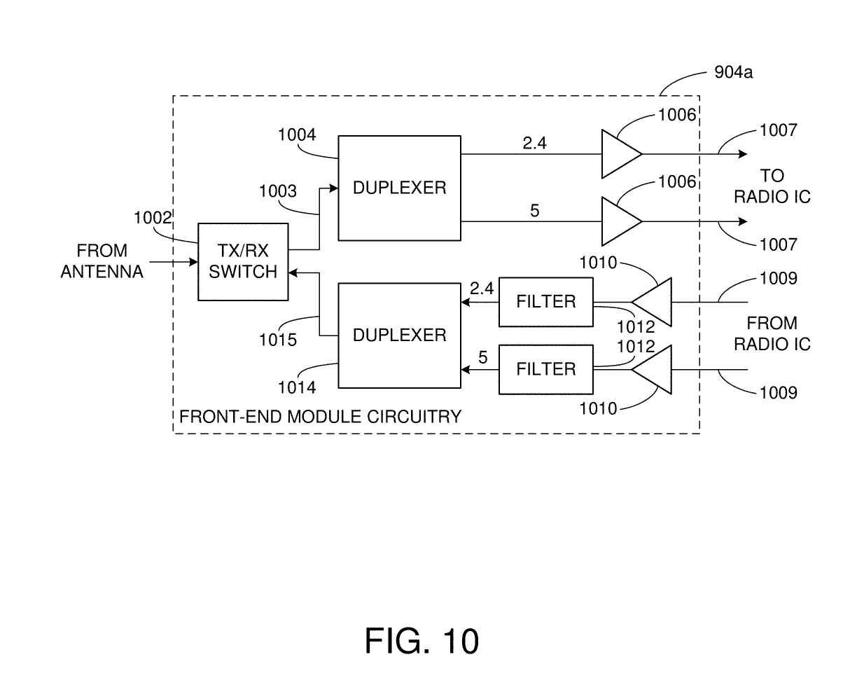

FIG. 10 illustrates WLAN FEM circuitry 904a in accordance with some embodiments. Although the example of FIG. 10 is described in conjunction with the WLAN FEM circuitry 904a, the example of FIG. 10 may be described in conjunction with the example BT FEM circuitry 904b (FIG. 9), although other circuitry configurations may also be suitable.

In some embodiments, the FEM circuitry 904a may include a TX/RX switch 1002 to switch between transmit mode and receive mode operation. The FEM circuitry 904a may include a receive signal path and a transmit signal path. The receive signal path of the FEM circuitry 904a may include a low-noise amplifier (LNA) 1006 to amplify received RF signals 1003 and provide the amplified received RF signals 1007 as an output (e.g., to the radio IC circuitry 906a-b (FIG. 9)). The transmit signal path of the circuitry 904a may include a power amplifier (PA) to amplify input RF signals 1009 (e.g., provided by the radio IC circuitry 906a-b), and one or more filters 1012, such as band-pass filters (BPFs), low-pass filters (LPFs) or other types of filters, to generate RF signals 1015 for subsequent transmission (e.g., by one or more of the antennas 901 (FIG. 9)) via an example duplexer 1014.

In some dual-mode embodiments for Wi-Fi communication, the FEM circuitry 904a may be configured to operate in either the 2.4 GHz frequency spectrum or the 5 GHz frequency spectrum. In these embodiments, the receive signal path of the FEM circuitry 904a may include a receive signal path duplexer 1004 to separate the signals from each spectrum as well as provide a separate LNA 1006 for each spectrum as shown. In these embodiments, the transmit signal path of the FEM circuitry 904a may also include a power amplifier 1010 and a filter 1012, such as a BPF, an LPF or another type of filter for each frequency spectrum and a transmit signal path duplexer 1004 to provide the signals of one of the different spectrums onto a single transmit path for subsequent transmission by the one or more of the antennas 901 (FIG. 9). In some embodiments, BT communications may utilize the 2.4 GHz signal paths and may utilize the same FEM circuitry 904a as the one used for WLAN communications.

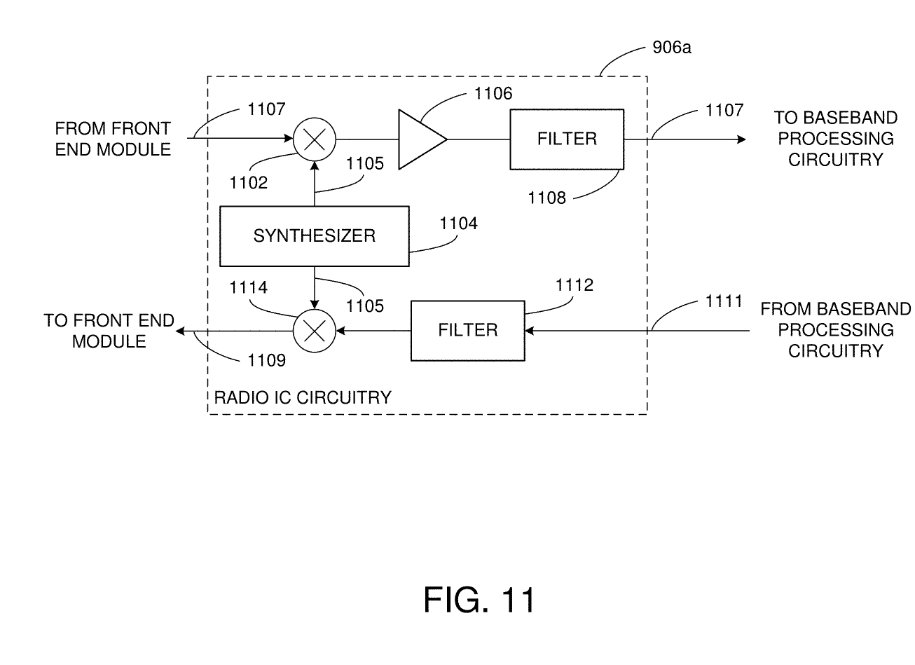

FIG. 11 illustrates radio IC circuitry 906a in accordance with some embodiments. The radio IC circuitry 906a is one example of circuitry that may be suitable for use as the WLAN or BT radio IC circuitry 906a/906b (FIG. 9), although other circuitry configurations may also be suitable. Alternatively, the example of FIG. 11 may be described in conjunction with the example BT radio IC circuitry 906b.

In some embodiments, the radio IC circuitry 906a may include a receive signal path and a transmit signal path. The receive signal path of the radio IC circuitry 906a may include at least mixer circuitry 1102, such as, for example, down-conversion mixer circuitry, amplifier circuitry 1106 and filter circuitry 1108. The transmit signal path of the radio IC circuitry 906a may include at least filter circuitry 1112 and mixer circuitry 1114, such as, for example, up-conversion mixer circuitry. Radio IC circuitry 906a may also include synthesizer circuitry 1104 for synthesizing a frequency 1105 for use by the mixer circuitry 1102 and the mixer circuitry 1114. The mixer circuitry 1102 and/or 1114 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 11 illustrates only a simplified version of a radio IC circuitry, and may include, although not shown, embodiments where each of the depicted circuitries may include more than one component. For instance, mixer circuitry 1114 may each include one or more mixers, and filter circuitries 1108 and/or 1112 may each include one or more filters, such as one or more BPFs and/or LPFs according to application needs. For example, when mixer circuitries are of the direct-conversion type, they may each include two or more mixers.

In some embodiments, mixer circuitry 1102 may be configured to down-convert RF signals 1007 received from the FEM circuitry 904a-b (FIG. 9) based on the synthesized frequency 1105 provided by synthesizer circuitry 1104. The amplifier circuitry 1106 may be configured to amplify the down-converted signals and the filter circuitry 1108 may include an LPF configured to remove unwanted signals from the down-converted signals to generate output baseband signals 1107. Output baseband signals 1107 may be provided to the baseband processing circuitry 908a-b (FIG. 9) for further processing. In some embodiments, the output baseband signals 1107 may be zero-frequency baseband signals, although this is not a requirement. In some embodiments, mixer circuitry 1102 may comprise passive mixers, although the scope of the embodiments is not limited in this respect.

In some embodiments, the mixer circuitry 1114 may be configured to up-convert input baseband signals 1111 based on the synthesized frequency 1105 provided by the synthesizer circuitry 1104 to generate RF output signals 1009 for the FEM circuitry 904a-b. The baseband signals 1111 may be provided by the baseband processing circuitry 908a-b and may be filtered by filter circuitry 1112. The filter circuitry 1112 may include an LPF or a BPF, although the scope of the embodiments is not limited in this respect.

In some embodiments, the mixer circuitry 1102 and the mixer circuitry 1114 may each include two or more mixers and may be arranged for quadrature down-conversion and/or upconversion respectively with the help of synthesizer 1104. In some embodiments, the mixer circuitry 1102 and the mixer circuitry 1114 may each include two or more mixers each configured for image rejection (e.g., Hartley image rejection). In some embodiments, the mixer circuitry 1102 and the mixer circuitry 1114 may be arranged for direct down-conversion and/or direct upconversion, respectively. In some embodiments, the mixer circuitry 1102 and the mixer circuitry 1114 may be configured for super-heterodyne operation, although this is not a requirement.

Mixer circuitry 1102 may comprise, according to one embodiment: quadrature passive mixers (e.g., for the in-phase (I) and quadrature phase (Q) paths). In such an embodiment, RF input signal 1007 from FIG. 11 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1105 of synthesizer 1104 (FIG. 11). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1007 (FIG. 10) may comprise a balanced signal, although the scope of the embodiments is not limited in this respect. The I and Q baseband output signals may be provided to low-noise amplifier, such as amplifier circuitry 1106 (FIG. 11) or to filter circuitry 1108 (FIG. 11).

In some embodiments, the output baseband signals 1107 and the input baseband signals 1111 may be analog baseband signals, although the scope of the embodiments is not limited in this respect. In some alternate embodiments, the output baseband signals 1107 and the input baseband signals 1111 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1104 may be a fractional-N synthesizer or a fractional N/N+1 synthesizer, although the scope of the embodiments is not limited in this respect as other types of frequency synthesizers may be suitable. For example, synthesizer circuitry 1104 may be a delta-sigma synthesizer, a frequency multiplier, or a synthesizer comprising a phase-locked loop with a frequency divider. According to some embodiments, the synthesizer circuitry 1104 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1104 may be provided by a voltage controlled oscillator (VCO), although that is not a requirement. A divider control input may further be provided by either the baseband processing circuitry 908a-b (FIG. 9) depending on the desired output frequency 1105. In some embodiments, a divider control input (e.g., N) may be determined from a look-up table (e.g., within a Wi-Fi card) based on a channel number and a channel center frequency as determined or indicated by the example application processor 910. The application processor 910 may include, or otherwise be connected to, one of the example secure signal converter 101 or the example received signal converter 103 (e.g., depending on which device the example radio architecture is implemented in).

In some embodiments, synthesizer circuitry 1104 may be configured to generate a carrier frequency as the output frequency 1105, while in other embodiments, the output frequency 1105 may be a fraction of the carrier frequency (e.g., one-half the carrier frequency, one-third the carrier frequency). In some embodiments, the output frequency 1105 may be a LO frequency (fLO).

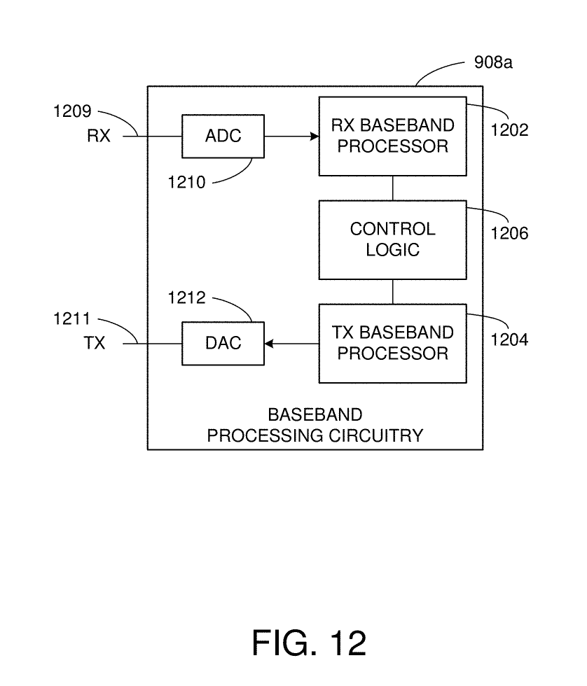

FIG. 12 illustrates a functional block diagram of baseband processing circuitry 908a in accordance with some embodiments. The baseband processing circuitry 908a is one example of circuitry that may be suitable for use as the baseband processing circuitry 908a (FIG. 9), although other circuitry configurations may also be suitable. Alternatively, the example of FIG. 11 may be used to implement the example BT baseband processing circuitry 908b of FIG. 9.

The baseband processing circuitry 908a may include a receive baseband processor (RX BBP) 1202 for processing receive baseband signals 1109 provided by the radio IC circuitry 906a-b (FIG. 9) and a transmit baseband processor (TX BBP) 1204 for generating transmit baseband signals 1111 for the radio IC circuitry 906a-b. The baseband processing circuitry 908a may also include control logic 1206 for coordinating the operations of the baseband processing circuitry 908a.

In some embodiments (e.g., when analog baseband signals are exchanged between the baseband processing circuitry 908a-b and the radio IC circuitry 906a-b), the baseband processing circuitry 908a may include ADC 1210 to convert analog baseband signals 1209 received from the radio IC circuitry 906a-b to digital baseband signals for processing by the RX BBP 1202. In these embodiments, the baseband processing circuitry 908a may also include DAC 1212 to convert digital baseband signals from the TX BBP 1204 to analog baseband signals 1211.

In some embodiments that communicate OFDM signals or OFDMA signals, such as through baseband processor 908a, the transmit baseband processor 1204 may be configured to generate OFDM or OFDMA signals as appropriate for transmission by performing an inverse fast Fourier transform (IFFT). The receive baseband processor 1202 may be configured to process received OFDM signals or OFDMA signals by performing an FFT. In some embodiments, the receive baseband processor 1202 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 9, in some embodiments, the antennas 901 (FIG. 9) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 901 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

What is claimed is:

1. A device, the device comprising processing circuitry coupled to storage, the processing circuitry configured to:
determine a first time associated with a first multicast transmission, wherein the first multicast transmission comprises a first basic service set identifier (BSSID), wherein the first BSSID is associated with a first BSS of a multi-BSSID set comprising the first BSS and a second BSS;
cause to send a frame, wherein the frame comprises the first time and the first BSSID, wherein the frame indicates that the second BSS is to ignore multicast transmissions at the first time, and wherein the first time is during a beacon interval associated with a beacon addressed to the multi-BSSID set;
cause to send the first multicast transmission at the first time; and
cause to send a second multicast transmission at a second time, wherein the second time is during the beacon interval, and wherein the second multicast transmission comprises a second BSSID associated with the second BSS.

2. The device of claim 1, wherein to determine the first time is based on a target beacon transmission time of a delivery traffic indication map (DTIM) for the first BSS plus a first offset, and wherein the processing circuitry is further configured to determine the second time based on a target beacon transmission time of a DTIM for the second BSS plus a second offset.

3. The device of claim 2, wherein the frame further comprises a first element associated with the first BSS and a second element associated with the second BSS, wherein the first element indicates the first offset, wherein the second element indicates the second offset.

4. The device of claim 2, wherein to determine the first time is based on a first service period of a broadcast target wake time (TWT), and wherein to determine the second time is based on a second service period of the broadcast TWT.

5. The device of claim 4, wherein the processing circuitry is further configured to:
determine the first service period based on a first flow identifier of the broadcast TWT; and
determine the second service period based on a second flow identifier of the broadcast TWT.

6. The device of claim 1, wherein the frame is a management frame, and wherein the frame further indicates the second time and the second BSS.

7. The device of claim 1, wherein the first time is different from the second time.

8. The device of claim 1, wherein the frame indicates a non-transmitted BSS identifier profile, and wherein the non-transmitted BSS identifier profile indicates the first time.

9. The device of claim 1, further comprising a transceiver configured to transmit and receive wireless signals, wherein the wireless signals comprise the first multicast transmission, the second multicast transmission, and the frame.

10. The device of claim 9, further comprising an antenna coupled to the transceiver.

11. A non-transitory computer-readable medium storing computer-executable instructions which when executed by one or more processors of a first device result in performing operations comprising:
determining a first time associated with a first multicast transmission, wherein the first multicast transmission comprises a first basic service set identifier (BSSID), wherein the first BSSID is associated with a first BSS of a multi-BSSID set comprising the first BSS and a second BSS;
causing to send a frame, wherein the frame comprises the first time and the first BSSID, wherein the frame indicates that the second BSS is to ignore multicast transmissions at the first time, and wherein the first time is during a beacon interval associated with a beacon addressed to the multi-BSSID set;
causing to send the first multicast transmission at the first time; and
causing to send a second multicast transmission at a second time, wherein the second time is during the beacon interval, and wherein the second multicast transmission comprises a second BSSID associated with the second BSS.

12. The non-transitory computer-readable medium of claim 11, wherein determining the first time is based on a target beacon transmission time of a delivery traffic indication map (DTIM) for the first BSS plus a first offset, the operations further comprising determining the second time based on a target beacon transmission time of a DTIM for the second BSS plus a second offset.

13. The non-transitory computer-readable medium of claim 12, wherein the frame further comprises a first element associated with the first BSS and a second element associated with the second BSS, wherein the first element indicates the first offset, wherein the second element indicates the second offset.

14. The non-transitory computer-readable medium of claim 12, wherein determining the first time is based on a first service period of a broadcast target wake time (TWT), and wherein determining the second time is based on a second service period of the broadcast TWT.

15. The non-transitory computer-readable medium of claim 14, the operations further comprising:
determining the first service period based on a first flow identifier of the broadcast TWT; and
determining the second service period based on a second flow identifier of the broadcast TWT.

16. The non-transitory computer-readable medium of claim 11, wherein the frame is a management frame, and wherein the frame further indicates the second time and the second BSS.

17. The non-transitory computer-readable medium of claim 11, wherein the frame indicates a non-transmitted BSS identifier profile, and wherein the non-transmitted BSS identifier profile indicates the first time.

18. The non-transitory computer-readable medium of claim 11, wherein the first time is different from the second time.

19. A method comprising:
determining, by one or more processors of a device, a first time associated with a first multicast transmission, wherein the first multicast transmission comprises a first basic service set identifier (BSSID), wherein the first BSSID is associated with a first BSS of a multi-BSSID set comprising the first BSS and a second BSS;
causing to send, by the one or more processors, a frame, wherein the frame comprises the first time and the first BSSID, wherein the frame indicates that the second BSS is to ignore multicast transmissions at the first time, and wherein the first time is during a beacon interval associated with a beacon addressed to the multi-BSSID set;
causing to send, by the one or more processors, the first multicast transmission at the first time; and
causing to send, by the one or more processors, a second multicast transmission at a second time, wherein the second time is during the beacon interval, and wherein the second multicast transmission comprises a second BSSID associated with the second BSS.

20. The method of claim 19, wherein determining the first time is based on a target beacon transmission time of a delivery traffic indication map (DTIM) for the first BSS plus a first offset, the method further comprising determining the second time based on a target beacon transmission time of a DTIM for the second BSS plus a second offset.
